(19) United States
(12) Patent Application Publication
(10) Pub. No.: US 2009/0160736 A1
(43) Pub. Date: Jun. 25, 2009

(54) AUTOMOTIVE HEAD UP DISPLAY APPARATUS

(75) Inventor: Kazuo SHIKITA, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/266,600

(22) Filed: Nov. 7, 2008

(30) Foreign Application Priority Data
Dec. 19, 2007 (JP) 2007-326705

(51) Int. Cl. G09G 5/00

(52) U.S. Cl. 345/7

(57) ABSTRACT

A HUD apparatus for vehicles including a light source, a scanning unit for scanning light from the light source two-dimensionally, a screen to focus the scanned light on, and a projection unit for projecting the image on the screen. The apparatus further includes a moving mechanism for changing the position of the screen.

### INCORPORATION BY REFERENCE

The present application claims priority from Japanese application JP-A-2007-326705 filed on Dec. 19, 2007, the content of which is hereby incorporated by reference into this application.

### FIELD OF THE INVENTION

This invention relates to a head-up display apparatus for vehicles for remotely displaying a travel information image, as a virtual image through a windshield, required for driving vehicles such as automobiles.

### BACKGROUND OF THE INVENTION

In the head-up display (hereinafter referred to as “HUD”) for vehicles such as automobiles, travel information (such as speed and navigation maps) is projected as a virtual image in superposition with a front scene beyond the front windshield (hereinafter referred to simply as “the windshield”) in the visual field as viewed from a driver. Incidentally, the image thus projected is hereinafter referred to as “the virtual image”. The display position of the virtual image of the projected travel information (i.e. the distance to the display position of the virtual image from the eye of the driver, hereinafter referred to as “the display distance”) is required to be set proper in such a manner as to minimize the movement of the visual line of the driver to visually recognize the travel information, i.e. in such a manner as to be capable of understanding the travel information while the focal point of the eye of the driver is coincident with the front scene of the visual field ahead of the driver. In other words, in accordance with the travel speed of vehicle, the display position (display distance) of the virtual image of the travel information is required to be changed (see, for example, JP-A-2004-168230, FIG. 2). Also, the HUD apparatus has a function of displaying a plurality of travel information such as the speed and the navigation map at the same time.

JP-A-2004-168230, for example, discloses a HUD apparatus comprising a light source, a plurality of display units (such as liquid crystal panels) arranged in superposition with each other at intervals of a predetermined distance in the direction of projection and a projection unit (such as a convex lens) for projecting the display image (also referred to simply as “the image”) on the display units, wherein the images on the display units are displayed without being superposed with each other in the direction of projection. In this configuration of the HUD apparatus, one of the plurality of display units is selected and the distance between the projection unit and the display unit is changed, thereby the display position (display distance) of the virtual image projected as a display image on the display unit can be changed. Also, by driving the plurality of display units at the same time, the plurality of display images can be projected at different positions (display distances) in a manner so as not to be superposed with each other in the direction of projection.

### SUMMARY OF THE INVENTION

As described in JP-A-2004-168230, the display distance can be changed by changing the distance between the projection unit and the display unit. Specifically, the distance between the projection unit and the display unit is changed in accordance with the travel speed of vehicle in such a manner that the virtual image is displayed far from the driver when the vehicle speed is high and near to the driver when the vehicle speed is low. In this way, the movement of the visual line of the driver can be less.

As well known, however, a change in the distance between the projection unit and the display unit also changes the magnification of the virtual image. In the case where the distance between the projection unit and the display unit is increased, for example, the position of the virtual image becomes farther from the driver, resulting in a larger magnification of the virtual image. In the case where the distance between the projection unit and the display unit is decreased, on the other hand, the position of the virtual image becomes nearer to the driver, resulting in a smaller magnification of the virtual image. Specifically, in the case where a plurality of travel information are displayed by driving a plurality of display units at the same time according to JP-A-2004-168230, the magnification varies from one display unit to another due to the different relative positions of the display units, thereby leading to a problem that the image (virtual image) is not unified in size and difficult to visually recognize.

Another problem of the method disclosed in JP-A-2004-168230 is that the projection of the image through a plurality of display units causes a large optical loss and reduces the brightness of the image.

This invention has been achieved in view of the problems described above, and the object thereof is to provide a head-up display apparatus for vehicles capable of projecting an image with a high brightness in a predetermined size regardless of the display distance of the virtual image projected.

In order to solve the problems described above, one feature of the invention is that the HUD apparatus for vehicles includes a light source, a scanning unit for scanning light from the light source two-dimensionally, a screen for focusing the scanning light thereon and a projection unit for projecting the image on the screen.

Another feature of the invention is that the apparatus includes a moving mechanism or a moving unit for adjusting the position of the screen.

Still another feature of the invention is that the apparatus includes a control circuit or a control unit for controlling at least the light source, the scanning unit, the moving mechanism and the moving unit.

Yet another feature of the invention is that the control unit is supplied with travel information which is the information on the travel motion, and the moving mechanism and the moving unit are controlled by the travel information so that the projection position of the virtual image projected by the projection unit or the deflection angle of the scanning unit is changed to change the size of virtual image.

A further feature of the invention is that the scanning unit is arranged in the neighborhood of the focal point of the projection unit.

A still further feature of the invention is that the apparatus include a plurality of screens each adapted to operate independently.

A yet further feature of the invention is that a MEMS mirror is used as the scanning unit.

Another feature of the invention is that a laser light source is used as the light source.

Still another feature of the invention is that a plurality of laser light sources are used as the light source, and the color gamut of the laser light sources includes the three primary colors of R, G, B.

With the HUD apparatus for vehicles according to the invention, the virtual image projected can be set to a predetermined size regardless of the display distance thereof. Also, a high brightness of the virtual image can be maintained.

Other objects, features and advantages of the invention will become apparent from the following description of the embodiments of the invention taken in conjunction with the accompanying drawings.

### BRIEF DESCRIPTION OF THE DRAWINGS

FIG. 1 is a side view schematically showing a head-up display apparatus for vehicles according to the first embodiment.

FIG. 2 is a diagram for explaining the movement of the virtual image according to the first embodiment.

FIG. 3 is a top plan view schematically showing the essential parts of the head-up display apparatus for vehicles according to the second embodiment.

FIGS. 4A and 4B are schematic diagrams for explaining an example of situation recognized by the driver using the head-up display apparatus for vehicles according to the second embodiment.

FIG. 5 is a side view schematically showing the head-up display apparatus for vehicles according to the third embodiment.

### DETAILED DESCRIPTION OF THE EMBODIMENTS

Embodiments of the invention are explained in detail below with reference to the drawings. In all the drawings, elements having the same function are designated by the same reference numeral and component elements once described are not described repeatedly.

### First Embodiment

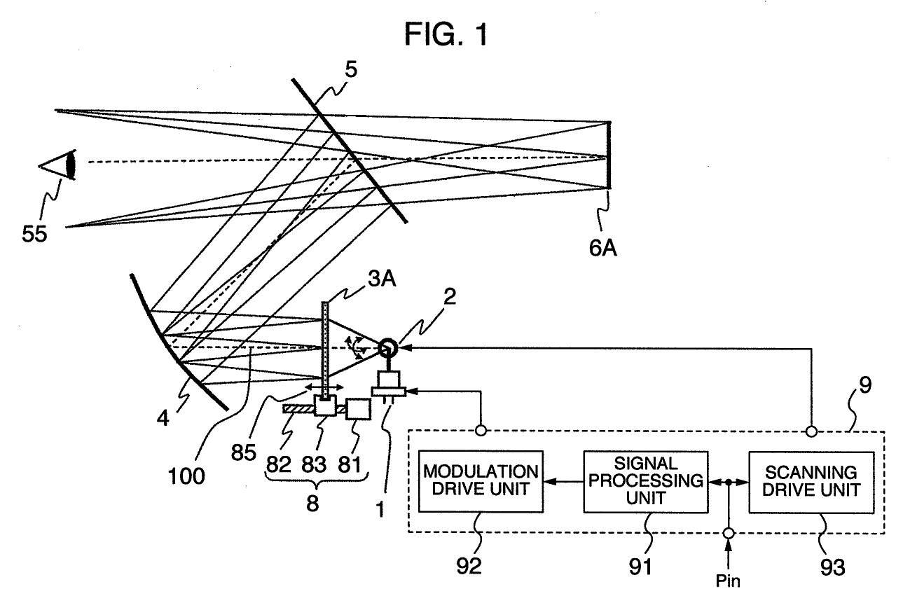

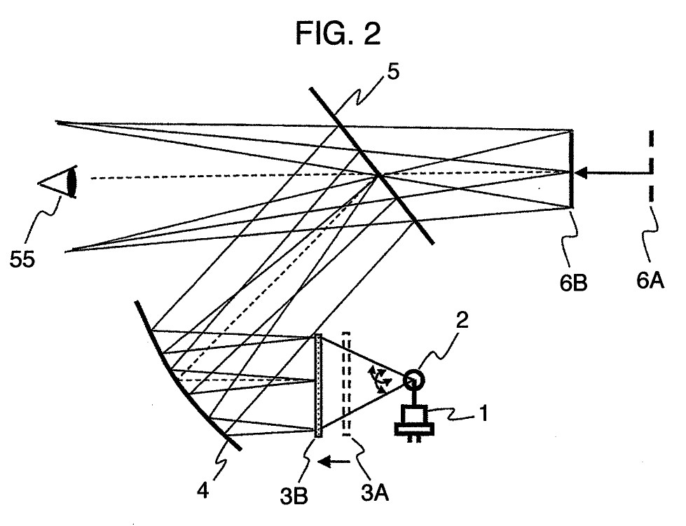

The HUD apparatus according to this embodiment for projecting a virtual image in a predetermined size regardless of the display distance thereof is explained below with reference to FIGS. 1 and 2.

FIG. 1 is a side view schematically showing the HUD apparatus according to the first embodiment. FIG. 2 is a diagram for explaining the movement of the virtual image according to this embodiment. In FIGS. 1 and 2, the elements with the position thereof moved are each designated by a reference numeral with a capital letter attached as an affix. Specifically, an element before movement is designated with “A” attached, and an element after movement with “B” attached. In an apparent case, however, the capital letters “A” and “B” will not be attached. In FIG. 2, the moving unit 8 and the control unit 9 are not shown for the sake of simplicity.

First, the configuration of the HUD apparatus according to this embodiment will be explained.

In FIG. 1, the HUD apparatus according to the first embodiment includes a light source 1, a scanning unit 2 for scanning the light from the light source 1 two-dimensionally, a screen 3 (3A in the case under consideration) on which the image (optical image) is plotted by the scanned light by the scanning unit 2, a moving unit 8 for adjusting the position of the screen 3 in the direction of projection (described later), a mirror 4 as a projection unit for reflecting and projecting the image on the screen 3 and a control circuit 9 for driving the scanning unit 2 while at the same time modulating the optical intensity of the light source 1 (hereinafter referred to as “modulating the light source 1”).

According to the first embodiment, an image display unit of scanning type including the light source 1, the scanning unit 2 and the screen 3 is used to generate an image.

The light source 1 emits a parallel beam. In the case under consideration, a laser light source such as a semiconductor laser or a solid laser for exciting the semiconductor laser is used. The light intensity of light emitted from the light source 1 is modulated by the control circuit 9 to emit a light beam modulated thereby (modulated light).

The scanning unit 2 scans the light beam from the light source 1 by two-dimensional deflection. In the case under consideration, a MEMS (Micro Electro Mechanical Systems) mirror using the micromachining technique, a Galvano mirror, a polygon mirror or a scanning unit including a plurality of these units is employed. Especially, the MEMS mirror can be used for miniaturization and is suitably applicable to the HUD apparatus. Since the MEMS mirror is described in detail, for example, in JP-A-2006-189573, it is not described in detail here. According to this invention, the scanning unit 2 is arranged in the vicinity of the focal point of the mirror 4 as described later.

A display image (optical image) such as travel information is plotted on the screen 3 by the two-dimensional scanning operation of the scanning unit 2, and the screen 3 thus constitutes the display unit of the HUD apparatus. Here, the screen 3 in this embodiment is a Fresnel screen, a diffusion screen or a screen combining a Fresnel lens and a diffusion plate.

The mirror 4 is a projection unit which reflects the image light from the screen 3 as a display unit and projects a virtual image 6 (6A in FIG. 1) in front of the eye 55 of the driver through the windshield 5. The screen 3 is arranged within the focal length f of the mirror 4 to project an enlarged virtual image. For the mirror 4, a spherical convex mirror, an aspheric convex mirror or a free curved surface mirror for correcting the distortion of the projected image is used.

The moving unit 8, as indicated by arrow 85, moves the screen 3, mounted thereon, longitudinally in the direction perpendicular to the surface of the screen 3 to adjust the position of the screen 3. To simplify the explanation, the direction in which the light emitted along the optical axis 100 (indicated by dotted line) of the HUD apparatus is referred to as “the direction of projection”. The moving unit 8 includes a motor 81 controlled by a control circuit not shown, based on the travel information output from an obstacle detector or a navigation system not shown, a feed screw 82 rotationally driven by the motor 81 and a rack 83 moved with the rotation of the feed screw 82 to move the screen 3 in the direction of projection (along the optical axis). The screen 3 is mounted on the rack 83, and the position of the screen 3 is adjusted by the rotation of the motor 81 based on the travel information or the like.

The control circuit 9 modulates the light source 1 based on the input video signal Pin while at the same time driving the scanning unit 2 for the scan operation. The control circuit 9 includes a video signal processing unit 91 for separating the video signal Pin into the primary color signals or processing the video signal in a predetermined manner, a modulation drive unit 92 for modulating the light source 1 based on the video signal processed in the video signal processing unit 91, and a scanning drive unit 93 for extracting a synchronized signal from the video signal Pin and driving the scanning unit 2 for the two-dimensional scanning operation based on the synchronized signal. The video signal Pin contains, for example, the travel information output from the navigation system or the obstacle detector not shown.

Next, the operation of the HUD apparatus will be explained.

The light source 1 is modulated based on the video signal such as travel information by the modulation drive unit 92 of the control circuit 9 thereby to generate a modulated light as the basis of an image. The modulated light emitted from the light source 1 is scanned two-dimensionally by the scanning unit 2 thereby to form an image distributed two-dimensionally on the screen 2. The image formed on the screen 2, after being reflected at the mirror 4 and at the windshield 5 of the vehicle, reaches the eye of the driver. In the process, a virtual image 6 is visually recognized by the eye 55 of the driver at a remote place ahead of the windshield 5.

Next, an explanation will be give about the feature of the HUD apparatus according to the invention that the virtual image of a predetermined size can be projected regardless of the display distance thereof.

The mirror 4 has a function of a lens. Let a be the distance from the screen 3 constituting a display unit to the mirror 4, b the distance from the mirror 4 to the virtual image 6, and f the focal length of the mirror 4. Then, as well known, a relationship expressed by Equation 1 holds.

$$\frac{1}{a} - \frac{1}{b} = \frac{1}{f} ( f > a ) \qquad [ Equation 1 ]$$

where a and b are absolute values, and 1/b is shown in negative sign to meet the condition, f>a, for displaying the virtual image.

Since the focal length f of the mirror 4 is a fixed value in Equation 1, with a decrease in the distance a between the screen 3 and the mirror 4, the distance b from the mirror 4 to the virtual image 6 also decreases. In FIG. 2, the screen 3B is located at the position where the screen 3A (indicated by dotted line) moved toward the mirror 4 by the moving unit 8. Accordingly, the position of the virtual image 6B corresponding to the screen 3B, is at the position where the virtual image 6A (indicated by a dotted line) corresponding to the screen 3A moved toward the windshield 5.

The magnification of the virtual image 6 can be expressed by Equation 2.

$$M = \frac{b}{a} = \frac{f}{f - a} \qquad [ Equation 2 ]$$

On the other hand, there is a relationship expressed by Equation 3 between the image size H on the screen 3 and the distance c from the scanning unit 2 to the screen 3.

H=A×c [Equation 3]

where A is a constant dependent on the scanning angle of the scanning unit 2 (hereinafter referred to as “the angular constant”).

Accordingly, from Equations 2 and 3, the size H′ of the virtual image 6 can be expressed by Equation 4.

$${H}^{′} = M \times H = \frac{fAc}{f - a} \qquad [ Equation 4 ]$$

Especially in the case where the scanning unit 2 is arranged at the focal point of the mirror 4, the relation, a+c=f, holds. By substituting the modified relation, c=f−a, into Equation 4, the size H′ of the virtual image 6 is expressed by Equation 5.

$${H}^{′} = \frac{Afc}{f - a} = \frac{Af ( f - a )}{f - a} = Af \qquad [ Equation 5 ]$$

As apparent from Equation 5, the size H″ of the virtual image 6 becomes a constant value Af, and thus, it becomes independent of the position of the screen 3. Specifically, even in the case where the display distance from the eye 55 of the driver to the virtual image 6 is changed by arranging the scanning unit 2 in the neighborhood of the focal point of the mirror 4 and changing the position of the screen 3, the size of the virtual image 6 can be kept constant without using a special control algorithm.

According to the conventional technique (for example, JP-A-2004-168230), the size of virtual image is changed in the case where the display distance is changed by changing the distance between the projection unit and the display unit. With an increase in display distance, for example, the size of virtual image also increases, and vice versa. In the case where the display distance is large, for example, if the display size of travel information, etc. is set to a predetermined size, a problem arose that a decreased display distance decreases the display size, thereby causing its visual recognition difficult.

According to this embodiment, on the other hand, the size of the virtual image 6 can be kept constant even in the case where the display distance is changed as described above. This size can be expressed as Af from Equation 5. Taking the case of a largest display distance and the case of a smallest display distance into consideration, a predetermined situation to secure a size easily visible can be set by the focal length f of the mirror 4 and the angular constant A of the scanning unit.

For example, in order to notify the driver of a danger in the neighborhood of the vehicle such as another vehicle passing or a sudden appearance of a pedestrian in front of the driven vehicle, a unit is required for attracting the attention of the driver's visual field to the neighborhood of the vehicle. This can be effectively achieved by forming a virtual image of a predetermined size indicating the danger in the neighborhood of the vehicle. According to the prior art, the size of virtual image becomes reduced with a decrease in the display distance in the neighborhood of the vehicle, and it is difficult to attract the visual field of the driver to the neighborhood of the vehicle. According to this embodiment, however, the virtual image can be kept in a predetermined size in spite of the decrease in display distance, so that the visual field of the driver can be satisfactorily attracted to the neighborhood of the vehicle.

As a matter of course, the size of the virtual image also can be changed. For example, in the case where the size is desired to be changed, a reference is set to a predetermined size Af, and the angular constant A is changed. In other words, the size of virtual image can be changed by changing the deflection angle of the scanning unit 2.

As described above, according to the first embodiment, there is provided a HUD apparatus for vehicles in which the display distance from the driver to the image (virtual image) can be adjusted as well as setting the virtual image to a predetermined constant size.

### Second Embodiment

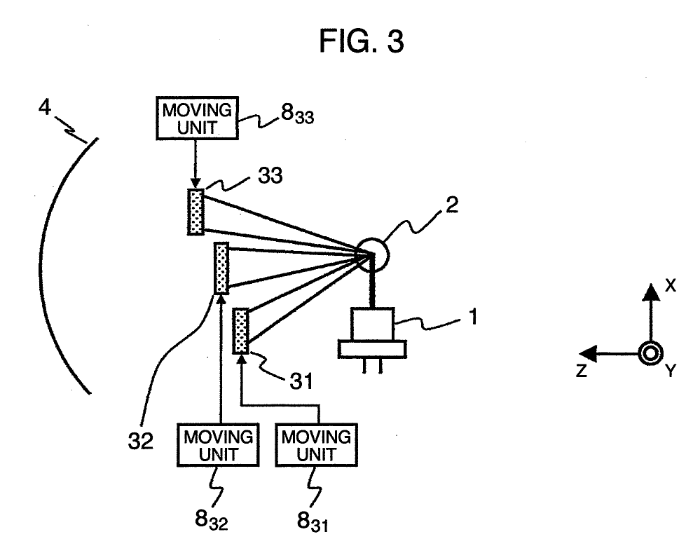

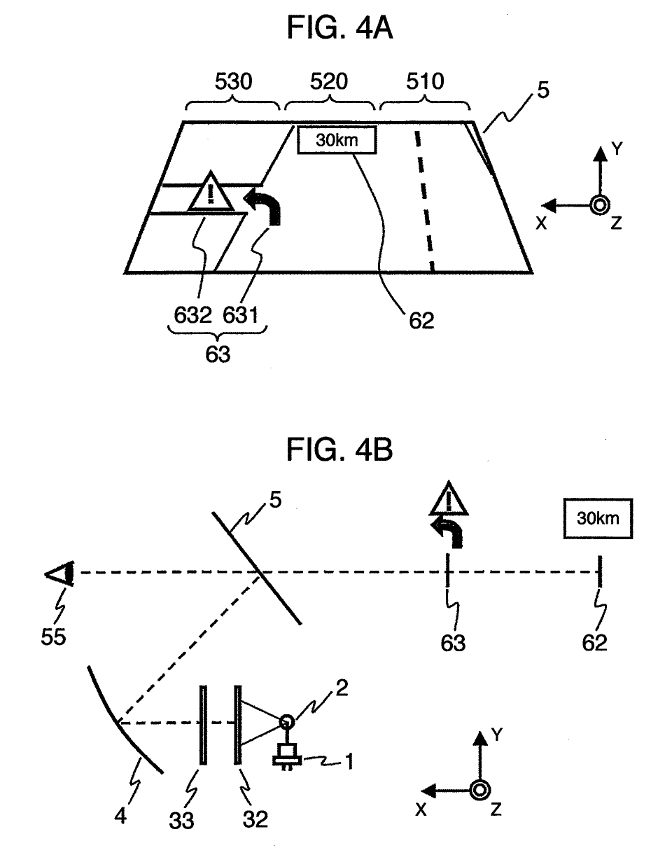

The HUD apparatus according to a second embodiment in which a plurality of travel information, for example, can be projected with high brightness using the technique of the first embodiment is explained below with reference to FIGS. 3 and 4.

FIG. 3 is a top plan view schematically showing the essential parts of the HUD apparatus having a plurality of screens according to the second embodiment. FIGS. 4A and 4B are schematic diagrams for explaining a situation in which the driver visually recognizes a virtual image of a plurality of travel information projected using the HUD apparatus according to the second embodiment. FIG. 4A is a diagram schematically showing the situation in which the driver visually recognizes a plurality of travel information superposed on a front scene in the forward visual field through the windshield, and FIG. 4B is a diagram for explaining the corresponding relationship between the display image and the virtual image of each display image formed on the plurality of screens, respectively. In FIGS. 3, 4A and 4B, the moving unit and the control circuit are not shown to simplify the illustration.

As apparent from FIG. 3, the HUD apparatus according to this embodiment has a plurality of screens as a feature thereof. According to this embodiment, the single screen 3 of the first embodiment is replaced with three screens 31, 32, 33 arranged substantially evenly, in the direction corresponding to the horizontal direction of the windshield 5, at such predetermined intervals as not to be superposed with each other as viewed from the scanning unit. Specifically, the images displayed on the three screens 31, 32, 33, as shown in FIG. 4A, are projected to the forward visual field of three areas 510, 520, 530 into which the windshield 5 is substantially trichotomized in the horizontal direction as viewed from the driver not shown. Incidentally, the deflection angle of the scanning unit 2 to each screen is substantially equal, so that the magnification of the virtual image corresponding to the display image on each screen is substantially equal to each other. Also, the positions of the display images on the screens 31, 32, 33 are horizontally reversed by the mirror 4. For example, the display image on the right screen 33 as viewed from the scanning unit in FIG. 3 is projected in the visual field ahead of the left area 530 on the windshield 5 as viewed from the driver not shown.

For simplicity of the description below, the XYZ orthogonal coordinate system with Z axis as a reference is introduced in FIG. 3. Specifically, the axis parallel to the direction of projection and directing from the scanning unit 2 toward the center of the screen 32 is assumed to be the Z axis, the axis parallel to the page in the plane and perpendicular to the Z axis to be the X axis (corresponding to the horizontally parallel axis in the windshield 5), and the axis perpendicular to the page in the plane and perpendicular to the Z axis to be the Y axis (corresponding to the vertically parallel axis in the windshield 5).

In FIG. 3, each screen 31, 32, 33 is arranged in parallel to the X-Y plane in such a manner that its X axis coordinate may not be superposed with each other. Also, the display image as an optical image is plotted on each screen 31, 32, 33 by the scanning unit 2 with a deflection angle in the X-Z plane divided into, for example, substantially three parts. Furthermore, each screen 31, 32, 33 has the moving unit 831, 832, 833, respectively. In other words, the screens can be adjusted independently each other in the direction parallel to Z axis. As a result, the image (display image) on each screen can be projected at different positions (i.e. different display distances) ahead of the windshield 5 without superposition.

In the HUD apparatus according to this embodiment having the configuration described above, light from each screen as a display unit does not transmit through the other screens located ahead in the direction of Z axis (direction of projection). As a result, there is provided a HUD apparatus in which, unlike in the prior art, a high brightness image can be projected without any optical loss.

Next, an example of the situation in which the driver visually recognizes a plurality of travel information using the HUD apparatus according to this embodiment will be explained with reference to FIGS. 4A, 4B.

According to this embodiment, the travel information is assumed to include a left turn display, for example, prompting the driver to turn left as a navigation display, a danger signal display warning the driver that a pedestrian is on the road after turning left, and a speed display. Incidentally, the navigation display can be directed from, for example, a well-known navigation system not shown. Also, the danger signal can be caught by an obstacle detector (not shown) for detecting obstacles using, for example, a reflection of laser light not shown. Specifically, the left turn display and the danger signal display are formed on the screen 33 by the scanning unit 2, while the speed display is formed on the screen 32. In this embodiment, nothing is displayed on the screen 31. In other words, the screen 31 and the corresponding virtual image are neither shown nor explained in FIGS. 4A and AB. In the case of right turn, on the other hand, a right turn display is of course plotted on the screen 31.

As described above, the left turn display and the danger signal display are plotted on the screen 33, while the speed display is plotted on the screen 32. Accordingly, in the visual field ahead of the area 530 of the windshield 5, a virtual image 631 for the left turn display and a virtual image 632 for the danger signal display (these virtual images are collectively designated by numeral 63) are projected at the position of the display distance corresponding to the left turn position by the position adjustment of the screen 33 using the moving unit 833. In the visual field ahead of the area 520 of the windshield 5, on the other hand, a virtual image 62 for speed display is projected at the position of the display distance farther than the displayed virtual image 63.

Generally, when the vehicle is driven, the focal point of the eye 55 of the driver is set on a front scene (a road, for example) far in the forward direction. Accordingly, as shown in FIG. 4A, the speed-display virtual image 62 is displayed at a far position of display distance in the neighborhood of the upper side of the space of FIG. 4A in the area 520. Under this condition, assume that the left-turn-display virtual image 631 is displayed in the neighborhood of the left turn position corresponding to the display distance of the left turn position, for example, by a navigation system not shown. The turn-left-display virtual image 631 is displayed substantially in the same size irrespective of the display distance as that of the speed-display virtual image 62, and therefore, the eye 55 of the driver is attracted to the left-turn-display virtual image 631. As a result, the eye 55 of the driver can visually recognize the left-turn-display virtual image 631 and the actual road to which the vehicle turns left, at the same time without adjusting the focal point. Also, in the process of turning left, the danger-signal-display virtual image 632 indicating the danger signal information detected by the obstacle detector not shown is additionally displayed. Thus, the danger-signal-display virtual image 632 can also be visually recognized at the same time, and an accident can be prevented. Also, by controlling the positions of the screens 32, 33 in keeping with the vehicle speed, an expression is possible in which a turn-left-display virtual image 631 indicating a left turn position approaches the driver with the progress of vehicle. Thus, a great variety of image expressions become possible.

The screen position can be adjusted or changed by the moving unit 8. Specifically, the screen position is adjusted or changed by inputting control signals (not shown in FIG. 1) from the control circuit 9 to the moving unit 8.

Also, the control signals (not shown in FIG. 1) input to the moving unit 8 from the control circuit 9 can be generated based on the travel information which is the information on travel motion.

The travel information which is the information on travel motion may be a travel speed related to a speed indicated on a speedometer while the vehicle is running, speed alarm information warning the driver to reduce the travel speed to secure safety or brake information urging the driver to apply the brake.

As another alternative, travel information may be danger information warning against any danger which may arise while the vehicle is running. In this sense of the words, danger signal information may also be included in the travel information.

Since the travel information is input to the control circuit 9, by controlling the moving unit 8 with the information on the travel speed contained in the travel information, the virtual image projected through the mirror 4 and the windshield 5 can be displayed in the visual field of the driver at a position farther ahead in the running direction (at a position farther from the driver in the running direction) when the vehicle speed is high than when the vehicle speed is low.

On the other hand, in the case where a danger exists in the neighborhood of the vehicle, the moving unit 8 may be controlled by the danger signal information contained in the travel information so as to project the virtual image at a position corresponding to the position of the existing danger.

As explained above, according to this embodiment, there is provided a HUD apparatus in which a plurality of images can be projected with high brightness at different display distances during the same time interval, or the projection position of the virtual image can be changed by the travel information to change the visual field or the position to which the driver's eye is attracted, so that the assist of safe driving becomes possible.

### Third Embodiment

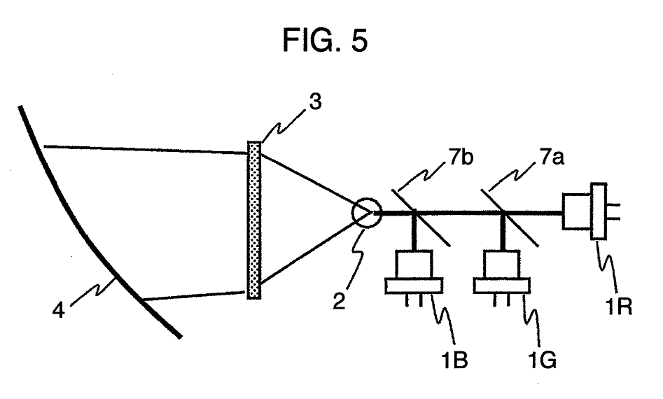

Next, a HUD apparatus for projecting a color display image according to the third embodiment will be explained. FIG. 5 is a side view schematically showing the essential parts of the optical system of the HUD apparatus according to the third embodiment.

As shown in FIG. 5, the HUD apparatus according to the third embodiment includes light sources 1R, 1G, 1B corresponding to the three primary colors of red (R), green (G) and blue (B), wavelength synthesis units 7a, 7b, a scanning unit 2, a screen 3 and a mirror 4. Though not shown, the HUD apparatus also of course includes a moving unit for moving the screen 3 and a control circuit for controlling the light sources 1R, 1G, 1B and the scanning unit 2.

The wavelength synthesis units 7a, 7b may be formed of, for example, a dichroic mirror, a dichroic prism or a diffraction element. The wavelength synthesis unit 7a according to this embodiment has such a characteristic that the red light wavelength region is transmitted while the other light wavelength region is reflected. The wavelength synthesis unit 7b, on the other hand, has such a characteristic that the red to green wavelength region is transmitted while he blue wavelength region is reflected. However, the order of the combination of wavelengths is not limited to the aforementioned case.

The light of each color emitted from the light sources 1R, 1G, 1B is superposed each other in the wavelength synthesis units 7a, 7b thereby to synthesize a colored light. The light thus synthesized is scanned two-dimensionally by the scanning unit 2, so that the color image display (optical image) of such as the travel information is plotted on the screen 3. Then, the color image display is projected by the mirror 4. In the process, the optical output of each light source 1R, 1G, 1B is modulated based on the color image signal thereby to project a virtual image in full-color display.

According to the embodiments described above, a HUD apparatus can be provided which has a high visibility with the full-color display.

It should be further understood by those skilled in the art that although the foregoing description has been made on embodiments of the invention, the invention is not limited thereto and various changes and modifications may be made without departing from the spirit of the invention and the scope of the appended claims.

1. A head-up display apparatus for vehicles characterized by comprising:
a light source;
a scanning unit for scanning light from said light source;
a screen on which the scanned light by said scanning unit is focused to form an image;
a projection unit for projecting the image focused and formed on said screen;
a moving unit for changing a screen position between said projection unit and said light source; and
a control unit for controlling said light source, said scanning unit or said moving unit.

2. The head-up display apparatus for vehicles according to claim 1,
characterized in that said projection unit comprises at least a mirror and a windshield.

3. The head-up display apparatus for vehicles according to claim 1,
characterized in that said scanning unit is arranged in the neighborhood of the focal point of said projection unit.

4. The head-up display apparatus for vehicles according to claim 1, comprising a plurality of screens as said screen;
characterized in that each screen operates independently.

5. The head-up display apparatus for vehicles according to claim 1,
characterized in that said scanning unit is a MEMS mirror.

6. The head-up display apparatus for vehicles according to claim 1,
characterized in that said light source is a laser light source.

7. The head-up display apparatus for vehicles according to claim 1,
characterized in that said light source includes a plurality of laser light sources having the color gamut of the three primary colors of R. G, B.

8. The head-up display apparatus for vehicles according to claim 1,
characterized in that the deflection angle of scanning by said scanning unit is changed under the control of said control circuit.

9. The head-up display apparatus for vehicles according to claim 1,
characterized in that said screen position is changed by controlling said moving unit under the control of said control circuit.

10. The head-up display apparatus for vehicles according to claim 1,
characterized in that said screen position is changed by controlling said moving unit under the control of said control circuit thereby to change the position of a virtual image projected by said projection unit.

11. The head-up display apparatus for vehicles according to claim 10,
characterized in that the distance of the projected position of the virtual image from the driver is set longer when the travel speed is high than when the travel speed is low, based on travel information on the travel motion input to said control circuit.

12. The head-up display apparatus for vehicles according to claim 2,
characterized in that said mirror includes a spherical concave mirror, an aspheric concave mirror and/or a free curved-surface mirror for correcting the distortion of projected images.
